(19) United States
(12) Patent Application Publication
(10) Pub. No.: US 2017/0309362 A1
(43) Pub. Date: Oct. 26, 2017

(54) MULTI-LAYERED GRAPHENE MATERIAL HAVING A PLURALITY OF YOLK/SHELL STRUCTURES

(71) Applicant: SABIC Global Technologies B.V., Bergen op Zoom (NL)

(72) Inventors: Yunyang Liu, Thuwal (SA); Ihab N. Odeh, Sugar Land, TX (US)

(21) Appl. No.: 15/534,316

(22) PCT Filed: Oct. 4, 2016
(86) PCT No.: PCT/US2016/055333

§ 371 Date: Jun. 8, 2017

Related U.S. Application Data
(60) Provisional application No. 62/253,995, filed on Nov. 11, 2015.

(51) Int. Cl. H01B 1/04

(52) U.S. Cl. CPC H01B 1/04; C01P 2004/64; C01P 2002/20; C01P 2004/90

(57) ABSTRACT

Multi-layered graphene materials and methods of making and use are described herein. A multi-layered graphene material can include a plurality of graphene layers having a plurality of intercalated nano- or microstructures that form a plurality of yolk/shell type structures. Each yolk/shell type structure can include at least two graphene layers that form a shell-like structure that encompasses a void space having at least one of the plurality of nano- or microstructures. The void space has a volume sufficient to allow for volume expansion of the at least one of the plurality of nano- or microstructures without deforming the shell-like structure.

### CROSS REFERENCE TO RELATED APPLICATIONS

This application claims benefit to U.S. Provisional Patent Application No. 62/253,995, filed Nov. 11, 2015, which is incorporated herein by reference in its entirety.

### BACKGROUND OF THE INVENTION

### A. Field of the Invention

The invention generally concerns a multi-layered graphene material that includes a plurality of graphene layers having a plurality of nano- or microstructures intercalated therein. This combination results in a graphene material having a multitude of yolk/shell like structures. Each yolk/shell like structure has a void space that allows for the intercalated nano- or micro-structure to expand without deforming the graphene layers. The materials of the present invention, in one non-limiting example, can be used as electrodes in rechargeable energy storage applications (e.g., secondary or rechargeable batteries, capacitors, supercapacitors, etc.).

### B. Description of Related Art

Graphene has exceptional properties ranging from high thermal conductivity, fast charged carrier mobility, and high Young's modulus. It has potential applications in energy storage devices, electrochemical devices, catalytic reactions, cell imaging devices, and drug delivery. One application that is getting a lot of attention is in lithium ion batteries or high rate supercapacitors. The storage capacity, power density, and cycling stability of a lithium ion battery depends strongly on the nature of the electrically active material (EA) and how it is supported and electrically connected to the current collector, which transfers electrons between the EA material and the outside world. In conventional Li ion batteries, graphite powder can be used as the negative electrode. The maximum storage capacity of graphene is determined by the chemical stoichiometry as one Li per six carbon atoms, giving a charge density of about 380 mAh/g of graphite. The storage capacity can be increased to greater than 3500 mAh/g, by using other metals that have a higher Li storage capacity such as silicon (Si) or tin (Sn).

A major obstacle to the use of these alternative materials is cycling stability. For example, the theoretical storage capacity of Si is about 10 times higher than graphene, but for negative electrodes made of silicon nanoparticles (e.g., particles of tens of nm diameter), the initial high capacity is lost after a few cycles to less than 10% of the theoretical capacity. Various attempts to increase the storage capacity of lithium have been disclosed. Chen et al., “Macroporous ‘bubble’ graphene film via template-directed ordered-assembly for high rate supercapacitors”, Chemical Communications, 202, 48, 7149-7151, describes using a hard templating strategy to fabricate a three-dimensional graphene film having a plurality of empty void spaces. U.S. Patent Application No. 20110284805 to Samulski et al. describes a method for making nanospacer-graphene composite materials where the graphene sheets are interspersed with nanospacers. U.S. Patent Application No. 20140329150 to de Guzman et al. describes a graphene composite that includes a plurality of nanoparticles embedded in graphene sheets. U.S. Pat. No. 8,778,538 to Kung et al. discloses an electrode material having a plurality of graphene sheets and electrically active materials. The graphene sheets remain in constant contact with the electrically active materials during lithiation and delithiation. In this regard, the Kung et al. material is designed to expand and contract due to the lack of sufficient spacing between the graphene sheets and the electrically active materials.

Despite all of the currently available research on graphene materials, many of these materials suffer from capacity degradation during charge-discharge cycles and only allow two-dimensional (2D) expansion of intercalated nanoparticles. Further, the continuous expansion/de-expansion cycle during lithiation and delithiation leads to structural failure of the graphene layers and ultimately battery failure.

### SUMMARY OF THE INVENTION

A solution to the problems associated with expansion and de-expansion of graphene materials has been discovered. The solution lies in the ability to design a graphene material that allows for the absorption of metal ions (e.g., lithium ions) with limited to no corresponding expansion of the graphene material. In particular, a yolk/shell-type architecture is introduced into the material, where the yolk can absorb metal ions and expand without causing the graphene material to expand. The graphene material includes a plurality of graphene layers having a plurality of intercalated nano- or microstructures and void space around each intercalated structure. This results in a graphene material having a multitude of yolk/shell structures, where the yolk is a nano- or microstructure and the shell is a combination of at least two graphene layers intercalating the yolk. This configuration allows for the three-dimensional expansion of the nano- or microstructure in the void space, thus reducing or avoiding expansion of the graphene material and ultimately lowering or eliminating damage to the graphene material. This is in contrast to 2D expansion typically associated with graphene materials such as those used in energy storage applications. Thus, one non-limiting use of the materials of the present invention is as an electrode (e.g., anode and/or cathode) in energy storage applications such as secondary battery applications (e.g., lithium-ion or lithium-sulfur batteries, capacitors, supercapacitors, etc.). When lithiated or charged, the materials of the present invention can be within 10%, 5%, 4%, 3%, 2%, 1%, or less of the volume of the materials in the delithiated or uncharged state. In preferred instances, the volume % difference between the charged and uncharged states of the materials of the present invention is within 5%, preferably, within 3%, or more preferably within 1% or less.

In one particular embodiment, a multi-layered graphene material is described. The multi-layered graphene material can include a plurality of graphene layers (e.g., reduced graphene oxide layers) having a plurality of intercalated nano- or microstructures that form a plurality of yolk/shell type structures. Each yolk/shell type structure can include at least two graphene layers that form a shell-like structure that encompasses a void space having at least one of the plurality of nano- or microstructures (e.g., 1, 2, 3, 4, 5, etc.). The void space has a volume sufficient to allow for volume expansion (e.g., at least 50% volume expansion, or 200% to 500% volume expansion) of the at least one of the plurality of nano- or microstructures without deforming the shell-like structure. Each void space can have an average volume of 5 nm³ to 10⁶ μm³. The nano- or microstructure(s) can fill 1% to 80%, preferably 30% to 60%, of the volume of each void space. The plurality of yolk-shell type structures is configured to 1) retain the plurality of nano- or microstructure(s) in the void spaces and 2) allow fluid, gas, ions to enter and exit the structures. In some instances, the graphene material has a flow flux of 1×10⁻⁹ to 1×10⁻⁴ mol m⁻²s⁻¹Pa. The nano- or microstructure can include silicon or an oxide or alloy thereof. In some instances, the nano- or microstructure(s) can include a metal, a metal oxide, a carbon-based nano- or microstructure, a metal organic framework, a zeolitic imidazolated framework, a covalent organic framework, or any combination thereof. The metal can be a noble metal (e.g., palladium (Pd), platinum (Pt), gold (Au), rhodium (Rh), ruthenium (Ru), rhenium (Re), Osmium (Os) or iridium (Ir), or any combinations or alloys thereof, or a transition metal (e.g., silver (Ag), copper (Cu), iron (Fe), nickel (Ni), zinc (Zn), manganese (Mn), chromium (Cr), molybdenum (Mo), tungsten (W), or tin (Sn), or any combinations or oxides or alloys thereof. Metal oxides can include silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. A diameter of each nano- or microstructure can range from 1 nm to 1000 nm, preferably 1 nm to 50 nm, or more preferably 1 nm to 5 nm. A total weight percentage of the nano- or microstructure(s) can range from 10 wt. % to 90 wt. %. The graphene material can be formed into a sheet or a film, and, in some instances, the sheet or film can have a thickness of 10 nm to 500 μm.

In another instance, an energy device that includes the multi-layered graphene material of the present invention is described. The energy device can be a rechargeable battery (e.g., a lithium-ion or lithium-sulfur battery). An anode and/or cathode of the battery can include the multi-layered graphene material. When charged or lithiated, the volume of the multi-layered graphene material is within 10%, 5%, 4%, 3%, 2%, 1%, or less of the volume of the multi-layered graphene material, when delithiated or uncharged.

In yet other embodiments, a catalytic membrane for catalyzing a chemical reaction, methods for using the catalytic membrane, and systems for producing a chemical product that include the catalytic membrane or the graphene material of the present invention are described. The membrane can include the multi-layered graphene material of the present invention. One method can include catalyzing a chemical reaction (e.g., a hydrocarbon cracking reaction, a hydrogenation of hydrocarbon reaction, and/or a dehydrogenation of hydrocarbon reaction, an environmental remediation reaction, and/or a 3-way catalytic converter reaction) where the material or the membrane is contacted with a reactant feed to catalyze the reaction and produce a product feed. A system for producing a chemical product can include (a) an inlet for a reactant feed; (b) a reaction zone that is configured to be in fluid communication with the inlet, and (c)an outlet configured to be in fluid communication with the reaction zone and configured to remove a product stream from the reaction zone. The reaction zone can include the multi-layered graphene material or the membrane of the present invention.

Methods of making the multi-layered graphene material of the present invention are also described. One method can include obtaining a composition that includes a plurality of graphene oxide layers having a plurality of intercalated composite nano- or microstructures that form a plurality of core/shell type structures. Each core/shell type structure can include at least two graphene layers that form a shell-like structure that encompasses at least one of the plurality of composite nano- or microstructures. The composite nano- or microstructures can include a removable polymeric matrix. The composition can be calcined to reduce the graphene oxide layers to graphene layers and to remove the polymeric matrix to produce the multi-layered graphene material of the present invention. Each of the composite nano- or microstructures is coated with the removable polymeric matrix. Removal of the matrix can convert the core/shell type structure into a yolk/shell type structure that encompasses a void space having a nano- or microstructure, where the void space has a volume sufficient to allow for volume expansion of the nano- or microstructure without deforming the shell-like structure. In some instances, each of the composite nano- or microstructures can include multiple nano- or microstructures contained within the polymeric matrix. Removal of the matrix can convert the core/shell type structure into a yolk/shell type structure that includes a void space having multiple nano- or microstructures where the void space has a volume sufficient to allow for volume expansion of the multiple nano- or microstructures without deforming the shell-like structure. The removable polymeric matrix can be, for example, a non-crosslinked, partially cross-linked or fully cross-linked polymeric matrix and, in some instances, include polystyrene (PS), functionalize PS, polymethyl methacrylate, or a siloxane-based polycarbonate. A portion of the single or multiple nano—or microstructures can be etched to increase the volume of the void space. Another method can include (a) obtaining a composition that includes a plurality of graphene oxide layers having a plurality of intercalated nano- or microstructures that form a plurality of core/shell type structures. Each core/shell type structure can include at least two graphene layers that form a shell-like structure that includes at least one nano- or microstructure(s) of the plurality of intercalated nano- or microstructures. In step (b), the composition can be calcined (e.g., at a temperature of 500° C. to 1000° C., preferably 700° C. to 900° C.) to reduce the graphene oxide layers to graphene layers. After calcining, in step 3, the plurality of nano- or microstructures can be etched away to produce the multi-layered graphene material of the present invention. Partial etching of the plurality of nano- or microstructures can convert the core/shell type structure into a yolk/shell type structure that includes a void space having at least one nano- or microstructure, where the void space has a volume sufficient to allow for volume expansion of the at least one nano- or microstructure without deforming the shell-like structure. The composition in step (a) can be obtained by subjecting a mixture of graphene oxide layers and nano- or microstructures or composite nano- or microstructures to vacuum filtration.

Also disclosed in the context of the present invention are embodiments 1-37. Embodiment 1 is a multi-layered graphene material that includes a plurality of graphene layers having a plurality of intercalated nano- or microstructures that form a plurality of yolk/shell type structures, each yolk/shell type structure comprising at least two graphene layers that form a shell-like structure that encompasses a void space having at least one of the plurality of nano- or microstructures, wherein the void space has a volume sufficient to allow for volume expansion of the at least one of the plurality of nano- or microstructures without deforming the shell-like structure. Embodiment 2 is the multi-layered graphene material of embodiment 1, wherein the void space has a volume sufficient to allow for at least 50% volume expansion, preferably 200% to 600% volume expansion of the at least one of the plurality of nano- or microstructures without deforming the shell-like structure. Embodiment 3 is the multi-layered graphene material of any one of embodiments 1 to 2 wherein each of the plurality of yolk-shell type structures encompasses a single nano- or microstructure. Embodiment 4 is the multi-layered graphene material of any one of embodiments 1 to 2, wherein each of the plurality of yolk-shell type structures encompasses at least two nano- or microstructures. Embodiment 5 is the multi-layered graphene material of any one of embodiments 3 to 4, wherein the nano- or microstructure(s) fills 1% to 80%, preferably 30% to 60%, of the volume of each void space. Embodiment 6 is the multi-layered graphene material of any one of embodiments 1 to 5, wherein the average volume of each void space is 5 nm³ to 10⁶ μm³. Embodiment 7 is the multi-layered graphene material of any one of embodiments 1 to 6, wherein the plurality of yolk-shell type structures are configured to allow fluid, gas, or ions to enter and exit the structures. Embodiment 8 is the multi-layered graphene material of any one of embodiment 1 to 7, wherein the material has a flow flux of 1×10⁻⁹ to 1×10⁻⁴ mol m⁻²s⁻¹Pa. Embodiment 9 is the multi-layered graphene material of any one of embodiments 1 to 8, wherein the plurality of yolk-shell type structures are configured to retain the plurality of nano- or microstructures in the void spaces. Embodiment 10 is the multi-layered graphene material of any one of embodiments 1 to 9, wherein the graphene layers are reduced graphene oxide layers. Embodiment 11 is the multi-layered graphene material of any one of embodiments 1 to 10, wherein the nano- or microstructures comprise silicon or an oxide or alloy thereof. Embodiment 12 is the multi-layered graphene material of any one of embodiments 1 to 11, wherein the nano- or microstructures comprises a metal, a metal oxide, a carbon-based nano- or microstructure, a metal organic framework, a zeolitic imidazolated framework, a covalent organic framework, or any combination thereof. Embodiment 13 is the multi-layered graphene material of embodiment 12, wherein the metal is a noble metal selected from the group consisting of palladium (Pd), platinum (Pt), gold (Au), rhodium (Rh), ruthenium (Ru), rhenium (Re), or iridium (Ir), osmium (Os), any combinations or alloys thereof. Embodiment 14 is the multi-layered graphene material of embodiment 12, wherein the metal is a transition metal selected from the group consisting of silver (Ag), copper (Cu), iron (Fe), nickel (Ni), zinc (Zn), manganese (Mn), chromium (Cr), molybdenum (Mo), tungsten (W), or tin (Sn), or any combinations or oxides or alloys thereof. Embodiment 15 is the multi-layered graphene material of embodiment 12, wherein the metal oxide is a metal oxide selected from silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. Embodiment 16 is the multi-layered graphene material of any one of embodiments 1 to 15, wherein each nano- or microstructures has a diameter of 1 nm to 1000 nm, preferably 1 nm to 50 nm, or more preferably 1 nm to 5 nm. Embodiment 17 is the multi-layered graphene material of any one of embodiments 1 to 16, wherein the material is in the form of a sheet or film. Embodiment 18 is the multi-layered graphene material of embodiment 17, wherein the sheet or film has a thickness of 10 nm to 500 μm. Embodiment 19 is the multi-layered graphene material of any one of embodiments 1 to 18, wherein the material comprises 10 wt. % to 90 wt. % of the plurality of nano- or microstructures.

Embodiment 20 is an energy storage device comprising the multi-layered graphene material of any one of embodiments 1 to 19. Embodiment 21 is the energy storage device of embodiment 20, wherein the energy storage device is a rechargeable battery. Embodiment 22 is the energy storage device of embodiment 21, wherein the rechargeable battery is a lithium-ion or lithium-sulfur battery. Embodiment 23 is the energy storage device of embodiment 22, wherein the multi-layered graphene material is comprised in an electrode of the battery. Embodiment 24 is the energy storage device of embodiment 23, wherein the volume of the multi-layered graphene material, when lithiated or charged, is within 10%, 5%, 4%, 3%, 2%, 1%, or less of the volume of the multi-layered graphene material, when unlithiated or uncharged. Embodiment 25 is a catalytic membrane for catalyzing a chemical reaction, the membrane comprising the multi-layered graphene material of any one of embodiments 1 to 19. Embodiment 26 is a method for catalyzing a chemical reaction with the multi-layered graphene material of any one of embodiments 1 to 19 or the membrane of embodiment 25, the method comprising contacting the material or the membrane with a reactant feed to catalyze the reaction and produce a product feed. Embodiment 27 is the method of embodiment 26, wherein the chemical reaction comprises a hydrocarbon cracking reaction, a hydrogenation of hydrocarbon reaction, and/or a dehydrogenation of hydrocarbon reaction, an environmental remediation reaction, and/or a 3-way catalytic converter reaction in automobiles.

Embodiment 28 is a system for producing a chemical product, the system comprising: (a) an inlet for a reactant feed; (b) a reaction zone that is configured to be in fluid communication with the inlet, wherein the reaction zone comprises the multi-layered graphene material of any one of embodiments 1 to 19 or the membrane of embodiment 28; and (c) an outlet configured to be in fluid communication with the reaction zone and configured to remove a product stream from the reaction zone. Embodiment 29 is a method of making the multi-layered graphene material of any one of embodiments 1 to 19, the method comprising: (a) obtaining a composition comprising a plurality of graphene oxide layers having a plurality of intercalated composite nano- or microstructures that form a plurality of core/shell type structures, each core/shell type structure comprising at least two graphene layers that form a shell-like structure that encompasses at least one of the plurality of composite nano- or microstructures, wherein the composite nano- or microstructures comprise a removable polymeric matrix; and (b) calcining the composition to reduce the graphene oxide layers to graphene layers and to remove the polymeric matrix to produce the multi-layered graphene material of any one of embodiments 1 to 19. Embodiment 30 is the method of embodiment 29, wherein each of the composite nano- or microstructures are coated with the removable polymeric matrix, and wherein removal of the matrix converts the core/shell type structure into a yolk/shell type structure that encompasses a void space having a nano- or microstructure, wherein the void space has a volume sufficient to allow for volume expansion of the nano- or microstructure without deforming the shell-like structure. Embodiment 31 is the method of embodiment 29, wherein each of the composite nano- or microstructures comprise multiple nano- or microstructures contained within the polymeric matrix, and wherein removal of the matrix converts the core/shell type structure into a yolk/shell type structure that encompasses a void space having multiple nano- or microstructures, wherein the void space has a volume sufficient to allow for volume expansion of the multiple nano- or microstructures without deforming the shell-like structure. Embodiment 32 is the method of any one of embodiments 29 to 31, wherein the removable polymeric matrix is non-crosslinked, partially or fully cross-linked. Embodiment 33 is the method of any one of embodiments 29 to 32, wherein the removable polymeric matrix comprises polystyrene (PS), functionalized PS, polymethyl methacrylate or a siloxane-based polycarbonate. Embodiment 34 is the method of any one of embodiments 29 to 33, further comprising partially etching away the nano- or microstructure(s) to increase the volume of the void space.

Embodiment 35 is a method of making the multi-layered graphene material of any one of embodiments 1 to 19, the method comprising: (a) obtaining a composition comprising a plurality of graphene oxide layers having a plurality of intercalated nano- or microstructures that form a plurality of core/shell type structures, each core/shell type structure comprising at least two graphene layers that form a shell-like structure that encompasses at least one of the nano- or microstructures of the plurality of intercalated nano- or microstructures; (b) calcining the composition to reduce the graphene oxide layers to graphene layers; and (c) partially etching away the plurality of intercalated nano- or microstructures to produce the multi-layered graphene material of any one of embodiments 1 to 19, wherein partial etching of the plurality of nano- or microstructures converts the core/shell type structure into a yolk/shell type structure that encompasses a void space having at least one nano- or microstructure, wherein the void space has a volume sufficient to allow for volume expansion of the at least one nano- or microstructure without deforming the shell-like structure. Embodiment 36 is the method of any one of embodiments 29 to 35, wherein the composition in step (a) is obtained by subjecting a mixture of graphene oxide layers and nano- or microstructures or composite nano- or microstructures to vacuum filtration. Embodiment 37 is the method of any one of embodiments 29 to 36, wherein the composition is calcined in step (b) at a temperature of 500° C. to 1000° C., preferably 700° C. to 900° C.

The following includes definitions of various terms and phrases used throughout this specification.

The phrase “multi-layered graphene” refers to a 2D (sheet-like) materials, either as free-standing films or flakes, or a substrate-bound coating, consisting of a small number (between 2 and about 10) of well-defined, countable, stacked graphene layers of extended lateral dimension as described in “All in the graphene family—A recommended nomenclature for two-dimensional carbon materials”, Carbon, 2013, 65, 1-6, which is incorporated herein by reference.

The “yolk/shell like structure” phrase encompasses both core/shell and yolk/shell structures, with the difference being that in a core/shell structure at least 50% of the surface of the “core” contacts the shell. By comparison, a yolk/shell structure includes instances where less than 50% of the surface of the “yolk” contacts the shell. In either instance, a void space is present in the yolk/shell like structure that has a volume sufficient to allow for volume expansion of the yolk or core without deforming the multi-layered graphene material or the plurality of graphene layers. The core or yolk can be a nano- or microstructure.

Determination of whether a core/shell or yolk/shell is present can be made by persons of ordinary skill in the art. One example is visual inspection of a transition electron microscope (TEM) or a scanning transmission electron microscope (STEM) image of a multi-layered graphene material or material of the present invention and determining whether at least 50% (core) or less (yolk) of the surface of a given nanostructure (preferably a nanoparticle) contacts a graphene layer.

“Nanostructure” refers to an object or material in which at least one dimension of the object or material is equal to or less than 1000 nm (e.g., one dimension is 1 to 1000 nm in size). In a particular aspect, the nanostructure includes at least two dimensions that are equal to or less than 1000 nm (e.g., a first dimension is 1 to 1000 nm in size and a second dimension is 1 to 1000 nm in size). In another aspect, the nanostructure includes three dimensions that are equal to or less than 1000 nm (e.g., a first dimension is 1 to 1000 nm in size, a second dimension is 1 to 1000 nm in size, and a third dimension is 1 to 1000 nm in size). The shape of the nanostructure can be of a wire, a particle (e.g., having a substantially spherical shape), a rod, a tetrapod, a hyper-branched structure, a tube, a cube, or mixtures thereof. “Nanoparticles” include particles having an average diameter size of 1 to 1000 nanometers.

“Microstructure” refers to an object or material in which at least one dimension of the object or material is greater than 1000 nm (e.g., greater than 1000 nm up to 5000 nm) and in which no dimension of the structure is 1000 nm or smaller. The shape of the microstructure can be of a wire, a particle, a sphere, a rod, a tetrapod, a hyper-branched structure, a tube, a cube, or mixtures thereof. “Microparticles” include particles having an average diameter size of greater than 1000 nm, preferably greater than 1000 nm to 5000 nm, or more preferably greater than 1000 nm to 10000 nm.

The term “about” or “approximately” are defined as being close to as understood by one of ordinary skill in the art. In one non-limiting embodiment, the terms are defined to be within 10%, preferably within 5%, more preferably within 1%, and most preferably within 0.5%.

The term “substantially” and its variations are defined to include the ranges within 10%, within 5%, within 1%, or within 0.5%.

The terms “wt. %”, “vol. %”, or “mol. %” refers to a weight, volume, or molar percentage of a component, respectively, based on the total weight, the total volume of material, or total moles, that includes the component. In a non-limiting example, 10 grams of component in 100 grams of the material is 10 wt. % of component.

The terms “inhibiting” or “reducing” or “preventing” or “avoiding” or any variation of these terms, when used in the claims and/or the specification includes any measurable decrease or complete inhibition to achieve a desired result.

The term “effective,” as that term is used in the specification and/or claims, means adequate to accomplish a desired, expected, or intended result.

The use of the words “a” or “an” when used in conjunction with any of the terms “comprising,” “including,” “containing,” or “having,” in the claims or the specification may mean “one,” but it is also consistent with the meaning of “one or more,” “at least one,” and “one or more than one.”

The words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The multi-layered graphene materials of the present invention can “comprise,” “consist essentially of,” or “consist of” particular ingredients, components, compositions, etc. disclosed throughout the specification. With respect to the transitional phase “consisting essentially of,” in one non-limiting aspect, a basic and novel characteristic of the multi-layered graphene materials of the present invention are there ability to absorption metal ions such as lithium ions with limited to no corresponding expansion of the graphene material.

Other objects, features and advantages of the present invention will become apparent from the following figures, detailed description, and examples. It should be understood, however, that the figures, detailed description, and examples, while indicating specific embodiments of the invention, are given by way of illustration only and are not meant to be limiting. Additionally, it is contemplated that changes and modifications within the spirit and scope of the invention will become apparent to those skilled in the art from this detailed description. In further embodiments, features from specific embodiments may be combined with features from other embodiments. For example, features from one embodiment may be combined with features from any of the other embodiments. In further embodiments, additional features may be added to the specific embodiments described herein.

### BRIEF DESCRIPTION OF THE DRAWINGS

Advantages of the present invention may become apparent to those skilled in the art with the benefit of the following detailed description and upon reference to the accompanying drawings.

FIG. 1 is a schematic of an embodiment of a method of making the graphene materials of the present invention.

FIG. 2 is a schematic of another embodiment of a method of making the graphene materials of the present invention.

FIG. 3 is a transmission electron microscope (TEM) image of synthesized graphene oxide (GO).

FIG. 4 is a Fourier transform infrared (FT-IR) spectrum of synthesized graphene oxide (GO).

FIG. 5 are X-ray diffraction (XRD) patterns of (a) graphite powder and (b) GO.

FIG. 6 is a scanning electron microscope (SEM) image of silicon powder.

FIG. 7 is a SEM image of Si@SiO₂ particles.

FIG. 8 is a SEM image of Si@SiO₂ particles for energy dispersive X-ray (EDX).

FIG. 9 are EDX results for Si@SiO₂ particles.

FIG. 10 is a SEM image of cross-section of Si@SiO₂/rGO film of the present invention for EDX.

FIG. 11 is a magnified SEM image of a cross-section of a Si@SiO₂/rGO film of FIG. 10.

FIG. 12 is a SEM image of the Si@SiO₂/rGO film of FIG. 10 for EDX.

FIG. 13 are EDX results of the Si@SiO₂/rGO film of FIG. 12.

FIG. 14 is a SEM image of a cross-section of Si/rGO yolk/shell film of the present invention.

FIG. 15 is a magnified cross-section SEM image of Si/rGO yolk/shell film of FIG. 14.

FIG. 16 is a SEM image of the Si/rGO yolk/shell film of FIG. 14 for EDX.

FIG. 17 are EDX results of the Si/rGO yolk/shell film of FIG. 16.

FIG. 18 are element maps for Si/rGO yolk-shell film of FIG. 17: (a) SEM image; (b) carbon; (c) oxygen; (d) silicon.

While the invention is susceptible to various modifications and alternative forms, specific embodiments thereof are shown by way of example in the drawings and may herein be described in detail. The drawings may not be to scale.

### DETAILED DESCRIPTION OF THE INVENTION

A solution that overcomes the problems associated with storage capacity and poor charge-discharge cycles for lithium type devices has been discovered. The solution is premised on a multi-layered graphene material that is structured to have a plurality of yolk/shell like structures created from a plurality of graphene layers and a plurality of nano- or microstructures intercalated therein. In certain non-limiting aspects, the nano- or microstructure can be electrically active materials (e.g., they attract and hold lithium ions). Without wishing to be bound by theory, it is believed that when the multi-layered graphene material is lithiated or charged, the nano- or microstructure expands (due to the addition of the lithium ion to the nano- or microstructure) inside the graphene layers and causes minimal to no deformation or expansion of the graphene layers. Notably, this architecture enables three dimensional expansion of the nano- or microstructure in the void space created between graphene layers and intercalated structures.

These and other non-limiting aspects of the present invention are discussed in further detail in the following sections with reference to the Figures.

### A. Preparation of a Multi-Layered Graphene Materials

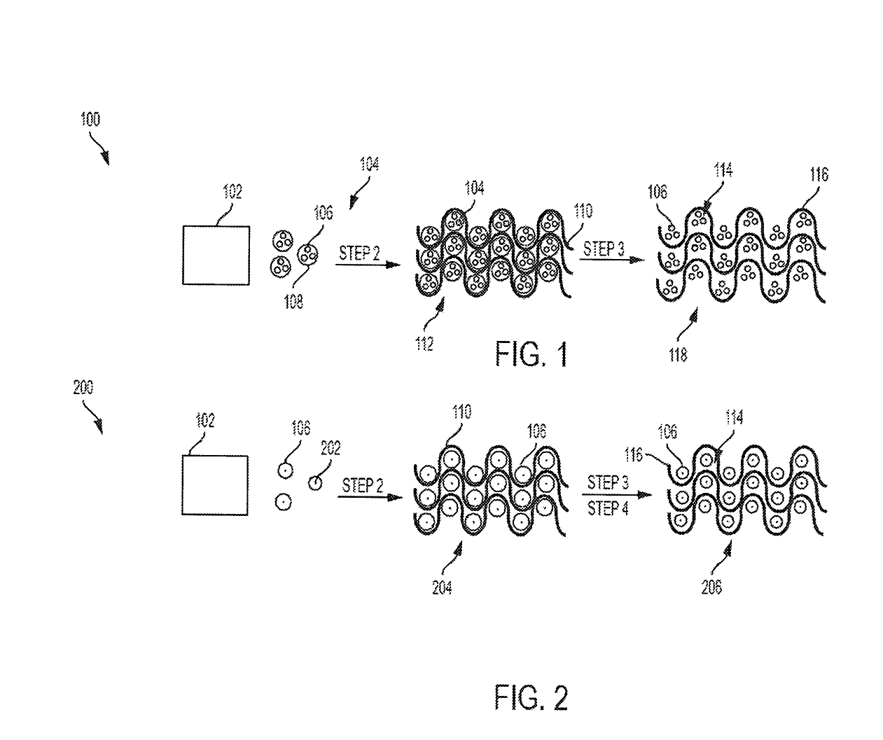

FIGS. 1 and 2 are schematics of methods of preparing multi-layered graphene materials having yolk-shell type structure. The methods can include one or more steps that can be used in combination to make a multi-structured graphene material.

1. Preparation of a Multi Nano-or Microstructure Yolks/Multi-Graphene Layer Shell Type-Structure

Referring to FIG. 1, step 1 of method 100 can include obtaining a plurality of graphene oxide layers 102 and a plurality of nano- or microstructure(s) composites 104. The nano- or microstructure(s) composite can include nano- or microstructure(s) 106 described below encapsulated in or coated with a removable polymeric matrix 108. The graphene layers used as starting materials can be obtained from a commercial source or made according to conventional processes. In a preferred embodiment, the graphene layers are graphene oxide layers.

a. Nano- and Microstructure Shapes and Materials

The nano- or micro structures can be made according to conventional processes (e.g., metal oxide nano- or microstructures made using alcohol or other reducing processes) or purchased through a commercial vendor. Non-limiting examples of nano- or microstructures that can be used include structures having a variety of shapes and/or made from a variety of materials. By way of example, the nanostructures can have the shape of a wire, a particle (e.g., having a substantially spherical shape), a rod, a tetrapod, a hyper-branched structure, a tube, a cube, or mixtures thereof. In a particular instance, the nanostructures are nanoparticles that are substantially spherical in shape. Selection of a desired shape has the ability to tune or modify the function of the graphene material. Non-limiting examples of nano- or microstructure materials that can be used include a metal, a metal oxide, a silicon compound, a carbon-based compound (e.g., a single or multi walled carbon nanotube), a metal organic framework compound, a zeolitic imidazolated framework compound, a covalent organic framework compound, a zeolite, or any combination thereof.

Non-limiting examples of metals include noble metals, transition metals, or any combinations or any alloys thereof. Noble metals include palladium (Pd), platinum (Pt), gold (Au), rhodium (Rh), ruthenium (Ru), rhenium (Re), osmium (Os), iridium (Ir) or any combinations or alloys thereof. Transition metals include iron (silver (Ag), Fe), copper (Cu), nickel (Ni), zinc (Zn), manganese (Mn), chromium (Cr), molybdenum (Mo), tungsten (W), or tin (Sn), or any combinations or alloys thereof. In some embodiments, the nano- or micro structure includes 1, 2, 3, 4, 5, 6, or more transition metals and/or 1, 2, 3, 4 or more noble metals. The metals can be obtained from metal precursor compounds. For example, the metals can be obtained as a metal nitrate, a metal amine, a metal chloride, a metal coordination complex, a metal sulfate, a metal phosphate hydrate, metal complex, or any combination thereof. Examples of metal precursor compounds include, nickel nitrate hexahydrate, nickel chloride, cobalt nitrate hexahydrate, cobalt chloride hexahydrate, cobalt sulfate heptahydrate, cobalt phosphate hydrate, platinum (IV) chloride, ammonium hexachloroplatinate (IV), sodium hexachloroplatinate (IV) hexahydrate, potassium hexachloroplatinate (IV), or chloroplatinic acid hexahydrate. These metals or metal compounds can be purchased from any chemical supplier such as Sigma-Aldrich (St. Louis, Mo., USA), Alfa-Aeaser (Ward Hill, Mass., USA), and Strem Chemicals (Newburyport, Mass., USA). Metal oxides include silica (SiO₂), alumina (Al₂O₃), titania (TiO₂), zirconia (ZrO₂), germania (GeO₂), stannic oxide (SnO₂), gallium oxide (Ga₂O₃), zinc oxide (ZnO), hafnia (HfO₂), yttria (Y₂O₃), lanthana (La₂O₃), ceria (CeO₂), or any combinations or alloys thereof. The metal or metal oxide nano- or microstructures can be stabilized with the addition of surfactants (e.g., CTAB, PVP, etc.) and/or through controlled surface charge.

MOFs are compounds having metal ions or clusters coordinated to organic molecules to form one-, two-, or three-dimensional structures that can be porous. In general, it is possible to tune the properties of MOFs for specific applications using methods such as chemical or structural modifications. One approach for chemically modifying a MOF is to use a linker that has a pendant functional group for post-synthesis modification. Any MOF either containing an appropriate functional group or that can be functionalized in the manner described herein can be used in the disclosed carbon nanotubes. Examples include, but are not limited to, IRMOF-3, MOF-69A, MOF-69B, MOF-69C, MOF-70, MOF-71, MOF-73, MOF-74, MOF-75, MOF-76, MOF-77, MOF-78, MOF-79, MOF-80, DMOF-1-NH₂, UMCM-1-NH₂, and MOF-69-80. Non-limiting examples of zeolite organic frameworks include zeolite imidazole framework (ZIFs) compounds such as ZIF-1, ZIF-2, ZIF-3, ZIF-4, ZIF-5, ZIF-6, ZIF-7, ZIF-8, ZIF-9, ZIF-10, ZIF-11, ZIF-12, ZIF-14, ZIF-60, ZIF-62, ZIF-64, ZIF-65, ZIF-67, ZIF-68, ZIF-69, ZIF-70, ZIF-71, ZIF-72, ZIF-73, ZIF-74, ZIF-75, ZIF-76, ZIF-77, ZIF-78, ZIF-79, ZIF-80, ZIF-81, ZIF-82, ZIF-86, ZIF-90, ZIF-91, ZIF-92, ZIF-93,

ZIF-95, ZIF-96, ZIF-97, ZIF-100 and hybrid ZIFs, such as ZIF-7-8, ZIF-8-90. Covalent organic frameworks (COFs) are periodic two- and three-dimensional (2D and 3D) polymer networks with high surface areas, low densities, and designed structures. COFs are porous, and crystalline, and made entirely from light elements (H, B, C, N, and O). Non-limiting examples of COFs include COF-1, COF-102, COF-103, PPy-COF 3 COF-102-C₁₂, COF-102-allyl, COF-5, COF-105, COF-108, COF-6, COF-8, COF-10, COF-11Å, COF-14 Å, COF-16 Å, OF-18 Å, TP-COF 3, Pc-PBBA, NiPc-PBBA, 2D-NiPc-BTDA COF, NiPc COF, BTP-COF, HHTP-DPB, COF-66, ZnPc-Py, ZnPc-DPB COF, ZnPc-NDI COF, ZnPc-PPE COF, CTC-COF, H2P-COF, ZnP-COF, CuP-COF, COF-202, CTF-1, CTF-2, COF-300, COF-LZU, COF-366, COF-42 and COF-43. Non-limiting examples of zeolites include Y-zeolites, beta zeolites, mordenite zeolites, ZSM-5 zeolites, and ferrierite zeolites. Zeolites may be obtained from a commercial manufacturer such as Zeolyst (Valley Forge, Pa., U.S.A.).

In some embodiments, the nano- or microstructures 106 are particles. The diameter of the core nano- or microstructures 106 can be 1 nm to 5,000, 1 nm to 1000 nm, 10 nm to 100 nm, 1 nm to 50 nm, or 1 nm to 5 nm, or 1, 2, 3, 4, 5, 6, 7, 8, 9, 10, 20, 30, 40, 50, 60, 70, 80, 90, 100, 150, 200, 250, 300, 350, 400, 450, 500, 550, 600, 650, 700, 750, 800, 850, 900, 950, 1000, nm, or any range or value there between.

The amount of nano- or microstructures (e.g., nanoparticles) in the multi-layer graphene material depends, inter alia, on the use of the multi-layer graphene material. In a particular instance, the multi-layer graphene material can include 10 wt. % to 90 wt. %, 20 wt. % to 80 wt. %, 30 wt. % to 70 wt. %, 40 wt. % to 60 wt. %, or any range or value there between of the nano- or microstructures. In embodiments when the multi-layer graphene material is used, as in catalytic applications, the amount of catalytic metal present in the particle(s) in the nanostructure ranges from 0.01 to 100 parts by weight of “active” catalyst structure per 100 parts by weight of multi-layer graphene material, from 0.01 to 5 parts by weight of “active” catalyst structure per 100 parts by weight of multi-layer graphene material. If more than one catalytic metal is used, the molar percentage of one metal can be 1 to 99 molar % of the total moles of catalytic metals in the multi-layer graphene material.

b. Polymeric Matrix

The polymeric matrix can be made from any polymer. The polymers are available from commercial vendors or made according to conventional chemical reactions. In some embodiments, the polymer is a thermoset polymer or blend thereof. The polymer matrix can be made from a composition having a thermoplastic polymer and can also include other non-thermoplastic polymers, additives, and the like, that can be added to the composition.

Thermoset polymeric matrices are cured or become cross-linked and tend to lose the ability to become pliable or moldable at raised temperatures. Non-limiting examples of thermoset polymers used to make the polymer film include epoxy resins, epoxy vinylesters, alkyds, amino-based polymers (e.g., polyurethanes, urea-formaldehyde), diallyl phthalate, phenolic polymers, polyesters, unsaturated polyester resins, dicyclopentadiene, polyimides, silicon polymers, cyanate esters of polycyanurates, thermosetting polyacrylic resins, phenol formaldehyde resin (bakelite), fiber reinforced phenolic resins (Duroplast), benzoxazines, or co-polymers thereof, or blends thereof. In addition to these, other thermoset polymers known to those of skill in the art, and those hereinafter developed, can also be used in the context of the present invention. The thermoset polymer can be included in a composition that includes said polymer and additives. Non-limiting examples of additives include coupling agents, antioxidants, heat stabilizers, flow modifiers, etc., or any combinations thereof. In some embodiments, one or more monomers capable of being polymerized when exposed to heat, light or electromagnetic force are used. Such monomers can be precursor materials suitable for forming thermoset polymers. The polymers and/or monomers are available from commercial vendors or made according to conventional chemical reactions.

Thermoplastic polymeric matrices have the ability to become pliable or moldable above a specific temperature and solidify below the temperature. The polymeric matrix of the material can include thermoplastic or thermoset polymers, co-polymers thereof, and blends thereof that are discussed throughout the present application. Non-limiting examples of thermoplastic polymers include polyethylene terephthalate (PET), a polycarbonate (PC) family of polymers, polybutylene terephthalate (PBT), poly(l,4-cyclohexylidene cyclohexane-1,4-dicarboxylate) (PCCD), glycol modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) and their derivatives, thermoplastic elastomer (TPE), terephthalic acid (TPA) elastomers, poly(cyclohexanedimethylene terephthalate) (PCT), polyethylene naphthalate (PEN), polyamide (PA), polysulfone sulfonate (PSS), sulfonates of polysulfones, polyether ether ketone (PEEK), polyether ketone ketone (PEKK), acrylonitrile butyldiene styrene (ABS), polyphenylene sulfide (PPS), co-polymers thereof, or blends thereof. In addition to these, other thermoplastic polymers known to those of skill in the art, and those hereinafter developed, can also be used in the context of the present invention. In some aspects of the invention, the preferred thermoplastic polymers include polypropylene, polyamide, polyethylene terephthalate, a polycarbonate (PC) family of polymers, polybutylene terephthalate, poly(phenylene oxide) (PPO), polyetherimide, polyethylene, co-polymers thereof, or blends thereof. In more preferred aspects, the thermoplastic polymers include polypropylene, polyethylene, polyamide, a polycarbonate (PC) family of polymers, co-polymers thereof, or blends thereof. The thermoplastic polymer can be included in a composition that includes said polymer and additives. Non-limiting examples of additives include coupling agents, antioxidants, heat stabilizers, flow modifiers, colorants, etc., or any combinations thereof.

In step 2, the graphene oxide layers 102 and the composites 104 can be suspended in an aqueous and/or nonaqueous medium and then vacuum filtered to intercalate the plurality of nano- or microstructure(s) composites between single graphene oxide layers 110 to form intercalated graphene material 112. Intercalated graphene material 112 includes a plurality of graphene oxide layers 110 with the composite 104 (e.g., a core) dispersed between the graphene layers. Two graphene oxide layers 110 form a shell-like material around the composite 104, thereby forming a core-shell type structure. The composites 104 can be in full or substantially full contact with graphene layers 110. In some embodiments, 50% to 100%, 50% to 99%, 60% to 95%, or 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or any range or value there between, of the surface of the composite 104 contacts the graphene layers 110.

In step 3, the intercalated graphene material 112, can be heated in the presence of air and/or inert gases (e.g., calcined) to remove the polymeric matrix 108 encapsulating the nano- or microstructure(s) 106, convert the nano- or microstructure(s) 106 to their oxide form, and/or convert the graphene oxide layers 110 to reduced graphene oxide layers 116 and form graphene material 118. Temperatures for heat treatment (e.g., calcining) can range from 500° C. to 1000° C., 700° C. to 900° C., or 500° C., 525° C., 550° C., 575° C., 600° C., 625° C., 650° C., 675° C., 700° C., 725° C., 750° C., 775° C., 800 ° C., 825° C., 850° C., 875° C., or 900° C., or any range or value there between. Removal of the polymeric matrix 108 forms void spaces 114 between the reduced graphene layers 116 and the nano- or microstructures 106. The plurality of nano- or microstructures 106 that have been uncoated during the calcination process are located in the void spaces 114 and between two reduced graphene layers 116, thereby forming a multi-yolk/shell like structure 118. After calcination, the formed graphene material 118 can be cooled to ambient temperatures, and then packaged for sale or distribution, stored, used in further processes or applications, formed into a sheet or film or any combination thereof.

c. Multi Nano-or Microstructure Yolks/Multi-Graphene Layer Shell Type-Structure

The multi-layered graphene material 118 includes void spaces 114 and each void space 114 includes a plurality of nano- or microstructures 106 or “multi-yolks”. As shown in FIG. 1, each void space 114 of the graphene material 118 includes 3 nano- or microstructure yolks, however, it should be understood that each void space can include 2, 3, 4, 5, or more nano- or microstructure yolks. The average volume of each void space can be 5 nm³ to 1,000,000 nm³ (10⁶ μm³) or 10 nm³ to 10⁵ μm³, 100 nm³ to 10⁴ μm³, or any range there between. The nano- or microstructure(s) 106 can fill less than 50%, 40%, 30%, or 20% of the volume of each void space (e.g., 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10% or less). The void spaces can have a volume sufficient to allow for volume expansion of the nano- or microstructure without deforming the graphene shell. In some instances, the void space can have volume sufficient to allow for at least 50% volume expansion, preferably 200% to 600%, or 50%, to 550%, 100% to 500%, 250% to 450% or any value there between (e.g., 50%, 75%, 100%, 125%, 150%, 175%, 200%, 225%, 250%, 275%, 300%, 325%, 350%, 375%, 400%, 425%, 450%, 475%, 500%, 525%, 550%, 575%, 600%) volume expansion of at least one of the nano- or microstructures 106 without deforming the graphene layers 116 (shell). In some instances, the graphene material has a flow flux of 1×10⁻⁹ to 1×10⁻⁴ mol m⁻²s⁻¹Pa.

2. Preparation of a Nano-or Microstructure Yolk/Multi-Graphene Layer Shell Type-Structure

Referring to FIG. 2, step 1 of method 100 can include obtaining a plurality of graphene oxide layers 102 and a plurality of nano- or microstructure(s) 106 described below. As shown nano- or microstructure 106 is a particle loaded with another metal 202, however, nano- or microstructure(s) 106 can be single structures, core-shell, yolk-shell type structures or the like. In step 2, the graphene oxide layers 102 and the nano- or microstructure(s) 106 can be suspended in an aqueous and/or nonaqueous medium and then vacuum filtered to intercalate the plurality of nano- or microstructure(s) 106 between single graphene oxide layers 110 to form intercalated graphene material 204. Intercalated graphene material 204 includes a plurality of graphene oxide layers 110 with the nano- or microstructure(s) 106 dispersed between the graphene layers. Two graphene oxide layers 110 form a shell-like material around one nano- or microstructure 106. The nano- or microstructure(s) 106 can be in full or substantially full contact with graphene layers 110. In some embodiments, 50% to 100%, 50% to 99%, 60% to 95%, or 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%, 99.7%, 99.8%, 99.9%, or any range or value there between, of the surface of the nano- or microstructures 106 contacts the graphene layers 110.

In step 3, the intercalated graphene material 204, can be heated in the presence of air and/or inert gases (e.g., calcined in air) to remove the polymer, convert the nano- or microstructures 106 to their oxide form and/or reduce the graphene oxide to reduced graphene oxide. Calcining temperatures can range from 500° C. to 1000° C., 700° C. to 900° C., or 500° C., 525° C., 550° C., 575° C., 600° C., 625° C., 650° C., 675° C., 700° C., 725° C., 750° C., 775° C., 800° C., 825° C., 850° C., 875° C., 900° C. or any range or value there between.

In step 4, the calcined graphene material can be subjected to a process that removes a portion of the outer surface or a shell of the nano- or microstructure(s) 106 to form void spaces 114. The void spaces can have a volume sufficient to allow for volume expansion of the nano- or microstructure without deforming the graphene shell. In some instances, the void space can have volume sufficient to allow for at least 50% volume expansion, preferably 200% to 600%, or 50%, to 550%, 100% to 500%, 250% to 450% or any value there between (e.g., 50%, 75%, 100%, 125%, 150%, 175%, 200%, 225%, 250%, 275%, 300%, 325%, 350%, 375%, 400%, 425%, 450%, 475%, 500%, 525%, 550%, 575%, 600%) of at least one of the nano- or microstructures 106 without deforming the graphene layers 116 (shell). In some instances when the nano- or microstructure(s) 106 are core/shell type structures, yolk/shell nano-or microstructures are formed during the removal of a portion of the outer surface of the nano- or microstructure(s) 106. By way of example, the calcined graphene material can be contacted with an etching solution (e.g., immersed in 10 wt. % HF aqueous solution) for a desired amount of time (e.g., for 5 to 30 minutes) to partially remove a portion or all of the outer surface of shell of nano- or microstructure(s) 106 to form the void space 114. The etching time, etching concentration, or type of etching agent or combinations thereof can be determined to obtain the desired volume of void space or a specific yolk/shell nano- or microstructure. Non-limiting examples of etching agents that can be used include hydrofluoric acid (HF), ammonium fluoride (NH₄F), the acid salt of ammonium fluoride (NH₄HF₂), sodium hydroxide (NaOH), nitric acid (HNO₃), hydrochloric acid (HCl), hydroiodic acid (HI), hydrobromic acid (HBr), boron trifluoride (BF₃), sulfuric acid (H₂SO₄), acetic acid (CH₃COOH), formic acid (HCOOH), or any combination thereof. In a certain embodiment, HF, NH₄F, NH₄HF₂, NaOH or any combination thereof can be used (e.g., in instances where a silica coating is removed from the surface of the nanostructure). In some embodiments, HNO₃, HCl, HI, HBr, BF₃, H₂SO₄, CH₃COOH, HCOOH, or any combination thereof can be used (e.g., to remove an alumina coating from the surface of the nanostructure). In another embodiment, a chelating agent (e.g., EDTA) for Al³⁻ can be added as an aid for faster etching of alumina in addition of above stated acids. Each etched nano- or microstructure 106 with metal loadings 202 is located in the created void space 114 between two reduced graphene layers 114, thereby forming a yolk-shell like structure.

a. Nano-or Microstructure Yolk/Multi-Graphene Layer Shell Type-Structure

The multi-layered graphene material 206 includes void spaces 114 and each void space 114 includes a single nano- or microstructures 106 or “yolk”. The average volume of each void space can be 5 nm³ to 1,000,000 nm³ (10⁶ μm³) or 10 nm³ to 10⁵ μm³, 100 nm³ to 10⁴ μm³, or any range there between. The nano- or microstructure(s) 106 can fill less than 50%, 40%, 30%, or 20% of the volume of each void space 114. The void spaces can have a volume sufficient to allow for volume expansion of the nano- or microstructure without deforming the graphene shell. In some instances, the void space can have volume sufficient to allow for at least 50% volume expansion, preferably 200% to 600% volume expansion of the at least one of the nano- or microstructures without deforming the graphene layers 116 (shell). In some instances, the graphene material has a flow flux of 1×10⁻⁹ to 1×10⁻⁴ mol m⁻²s⁻¹Pa.

### B. Articles of Manufacture and Applications of the Multi-layered Graphene Material

The multi-layered graphene materials 118 and 206 can be included in articles of manufacture, made into sheets, films, or incorporated into membranes. The sheet or film can have a thickness of 10 nm to 500 μm. The article of manufacture can include an electronic device, a gas or liquid separation membrane, a catalytic membrane for catalyzing a chemical reaction, a catalyst material, a controlled release medium, a sensor, a structural component, an energy storage device, a gas capture or storage material, or a fuel cell. In a particular instance, the multi-layer graphene materials of the present invention are used in an energy storage device. Non-limiting examples of energy storage devices include rechargeable batteries (e.g., lithium-ion or lithium-sulfur batteries). In some instances, the multi-layered graphene material with electroactive nano- or microstructures can be included in the electrode of the lithium battery. For example, the multi-layered graphene material with electroactive nano- or microstructures can be included in an anode in lithium-ion batteries when silicon is included in the anode. When the battery is charged, the lithium ions are attracted to the electroactive nano- or microstructures (e.g., silicon) intercalated in the reduced graphene layers 116. The lithium ions can be electrostatically attached to the electroactive nano- or microstructures and form lithiated electroactive nano- or microstructures. Due to the lithiation, the volume of the lithiated electroactive nano- or microstructures is increased as compared to the unlithiated nano- or microstructures. Since the nano- or microstructures are positioned in a 3-dimensional void space, they have sufficient space to expand, while the total volume of the multi-layered graphene material remains substantially unchanged. For example, volume of the multi-layered graphene material, when lithiated or charged, can be within 10%, 5%, 4%, 3%, 2%, 1%, or less of the volume of the multi-layered graphene material, when unlithiated or uncharged.

In some instances, the multi-layered graphene materials 118 and 206, or membrane that includes the multi-layered graphene materials, can be used in a variety of chemical reactions. Non-limiting examples of chemical reactions include oxidative coupling of methane reaction, a hydrogenation reaction, a hydrocarbon cracking reaction, an alkylation reaction, a denitrogenation reaction, a desulfurization reaction, a Fischer-Tropsch reaction, a syngas production reaction, a 3-way automobile catalysis reaction, reformation reactions, hydrogen generation reaction.

The methods used to prepare the multi-layered graphene materials 118 and 206 of the present invention can be modified or varied as desired to design or tune the size of the void space, the selection of catalytic metal-containing particles, the dispersion of the nano- or microstructures in the graphene layers, the porosity and pore size of the graphene material, etc., to design an article of manufacture, an energy storage device or other devices, or a catalyst for a specific chemical reaction.

### EXAMPLES

The present invention will be described in greater detail by way of specific examples. The following examples are offered for illustrative purposes only, and are not intended to limit the invention in any manner.

Instrumentation. Powder X-ray diffraction (XRD) patterns were measured from a Bruker D8 Advance X-ray Diffractometer (Bruker Instruments, U.S.A.) with CuKα radiation λ=0.154056 nm at 40 kV and 40 mA. Scanning electron microscopy (SEM) images and Energy Dispersive X-Ray Spectroscopy (EDX) were taken by a FEI Quanta 600 FEG (FEI Company, U.S.A). Fourier transform infrared spectra (FT-IR) were acquired using a NICOLET-6700 FT-IR spectrometer (Nicolet Instrument Corporation, U.S.A.). Transmission electron microscope (TEM) images were obtained by evaporating a drop of ethanol dispersion of nanoparticles on carbon-coated copper grids followed by the measurement on Tecnai Twin TEM operating at 120 kV (FEI Company, U.S.A).

### Example 1

### Synthesis and Characterization of Graphene Oxide (GO)

The oxidation of graphite was carried out following the Hummers' method (Hummers et al., J. Am. Chem. Soc., 1958, 80, 1339-1339). In a typical procedure, KNO₃ (12 g) and graphite (10 g) were added into concentrated H₂SO₄ (98%, 500 mL) under stirring. After 10 min, KMnO₄ (60 g) was added slowly. The mixture was then heated to 35° C. and stirred for 6 hours. Water (800 mL) was then added dropwise under vigorous stirring, resulting in a quick rise of the temperature to about 80° C. The slurry was stirred at 80° C. for another 30 mins. Afterwards, water (2 L) and H₂O₂ (30%, 60 mL) were added in sequence to dissolve insoluble manganese species. The resulting graphite oxide suspension was washed repeatedly by a large amount of water until the solution pH reached a constant value of about 4.0, and finally the suspension was further diluted with water (600 mL). The diluted graphite oxide suspension (200 mL) was transferred into a conical container and the suspension was gently shaken in a mechanical shaker at a speed of 160 rpm for about 6 hours. To remove the small amount of unexfoliated particles, the resulting viscous suspension was centrifuged at 2,000 rpm for 10 min, producing a brown, homogeneous colloidal suspension of GO sheets. The colloidal suspension, when necessary, was further concentrated by centrifugation at 8,000 rpm.

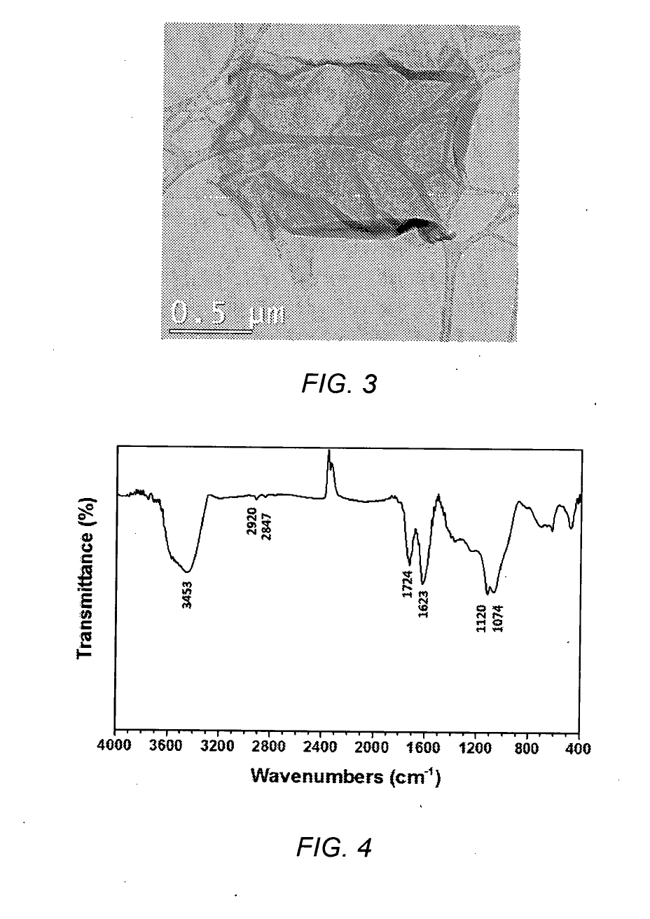

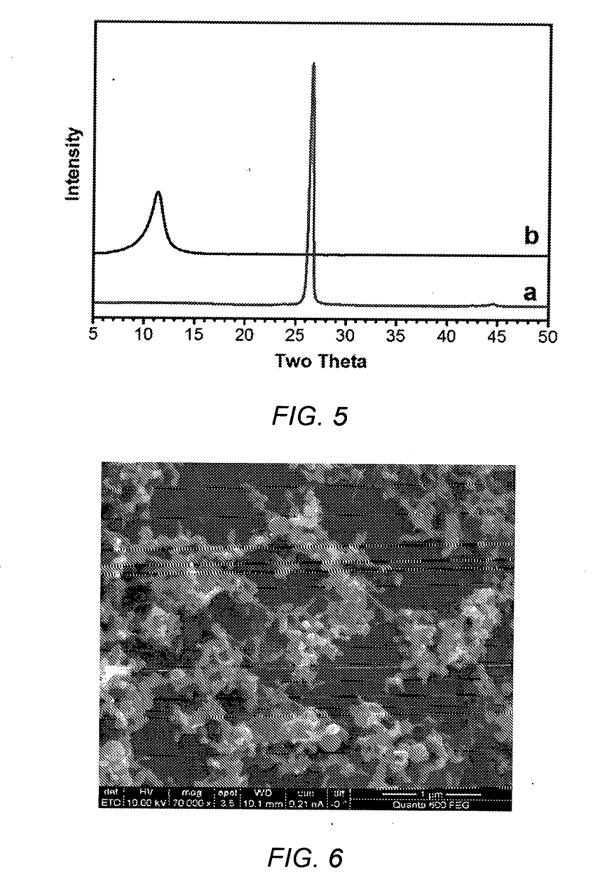

FIG. 3 shows a TEM image of the synthesized graphene oxide. FIG. 4 shows a FT-IR spectrum of the GO powder. The stretching vibration at 3453 cm⁻¹ refers to the —OH stretch of the oxidized graphene. The vibrational bands at 2920 cm⁻¹ and 2847 cm⁻¹ are attributed to alkane (—CH₂) stretches. The absorption band at 1724 cm⁻¹ corresponds to carbonyl (C═O) stretches from carbonyl or conjugated carbonyl groups. The bands at 1623 cm⁻¹ has been assigned to carbon-carbon double bond (C═C) stretches. The absorption peaks at 1220 cm⁻¹ and 1074 cm⁻¹ are assigned to carbon-oxygen-carbon stretches (C—O—C) from epoxy or ether functionality, and carbon-oxygen stretched (C—O) from alkoxy functionality, respectively. These results are in agreement with literature reports. FIG. 5 shows XRD patterns of phase structure of graphite powder (a) and GO (b). The graphite powder (a) exhibited a sharp peak at 26.5 degrees (a). In contrast, GO powder (b) showed a characteristic broad peak at 11.3 degrees.

### Example 2

### Synthesis and Characterization of Si@SiO₂ Core-Shell Particles

Silicon powder (0.5 g, 100 nm, Sigma-Aldrich®, U.S.A.) was dispersed in ethanol (200 mL), and then mixed with aqueous ammonium (25%, 6 mL and 20 mL water). Tetraethyl orthosilicate (TEOS) (30 mL) in ethanol (20 mL) was added dropwise to the mixture, and then stirred for 3 days. The resultant particles were purified by centrifugation and washed with ethanol (3 times). After drying at 80° C. under vacuum, a yellow powder of Si@SiO₂ core-shell particles were obtained.

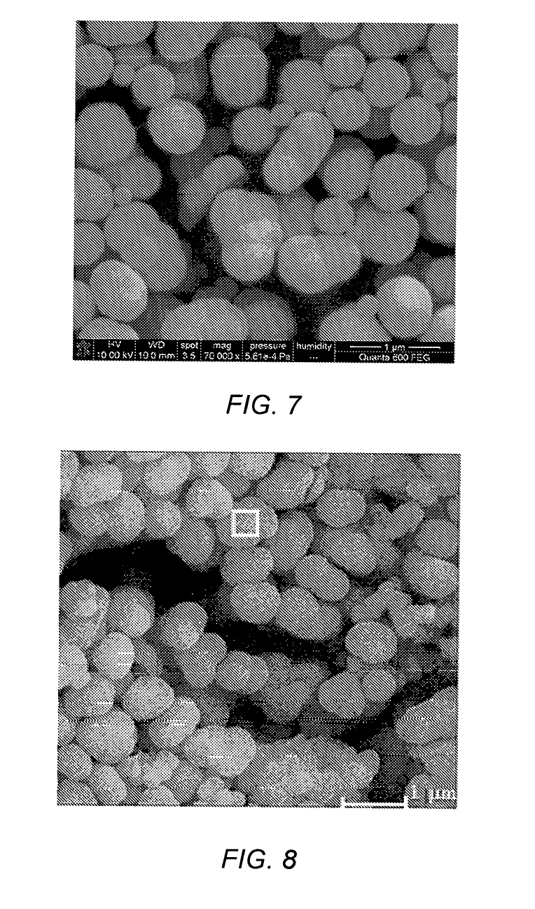

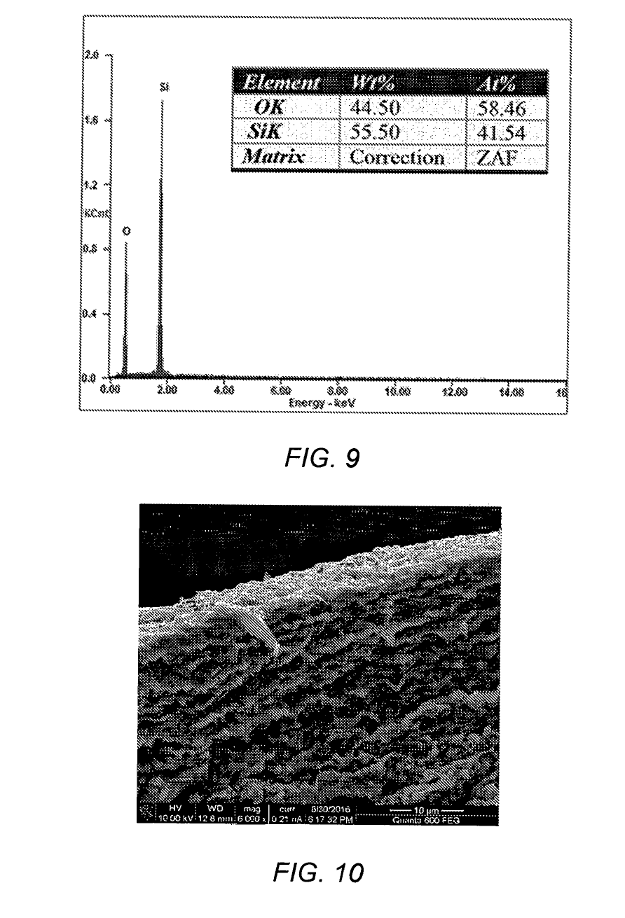

FIG. 6 shows a SEM image of silicon power used to prepare the core-shell structure. FIG. 7 is the SEM image of Si@SiO₂ core-shell particles as-synthesized in this Example. EDX was used to analyze the component of Si@SiO₂ particles. The white square area was selected for analysis (FIG. 8). From EDX results (FIG. 9), the ratio of Si/SiO₂ was 0.42.

### Example 3

### Synthesis and Characterization of Si@SiO₂/Reduced Graphene Oxide Composite Core-Shell Film (Si@SiO₂/rGO)

Si@SiO₂ particles (0.1 g, Example 2) and graphene oxide (0.2 g, Example 1) were dispersed in H₂O (20 mL) using a Sonic Dismembrator (Fisher Scientific, Model 550), and then filtered by vacuum to form a film. The film was then sandwiched between graphite plates and loaded in a tubular furnace. After purging the tube with argon, the film was heated from room temperature to 100° C. at 2° C. /min and held for 30 min, heated to 200° C. at 2° C./min and held for 30 min, heated to 800° C. at 5° C. /min and held for 1 hour, then cooled to room temperature under argon.

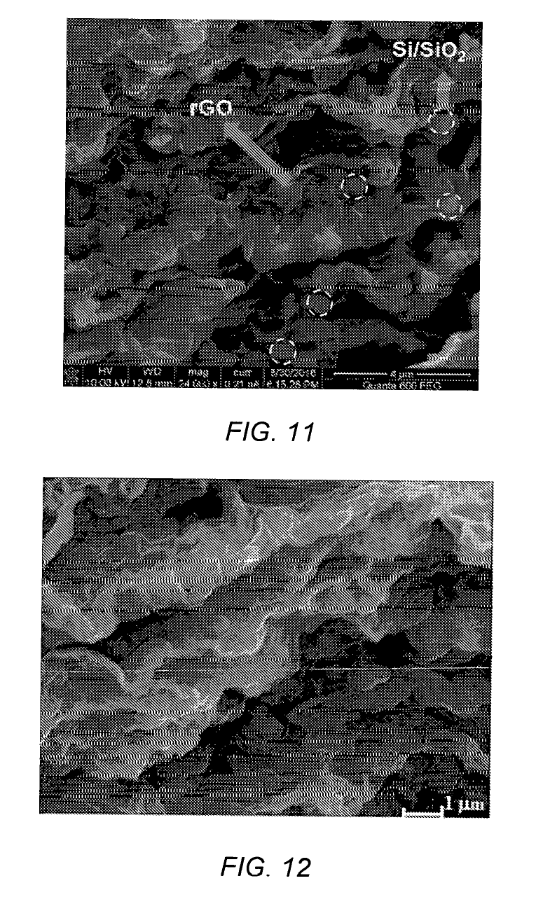

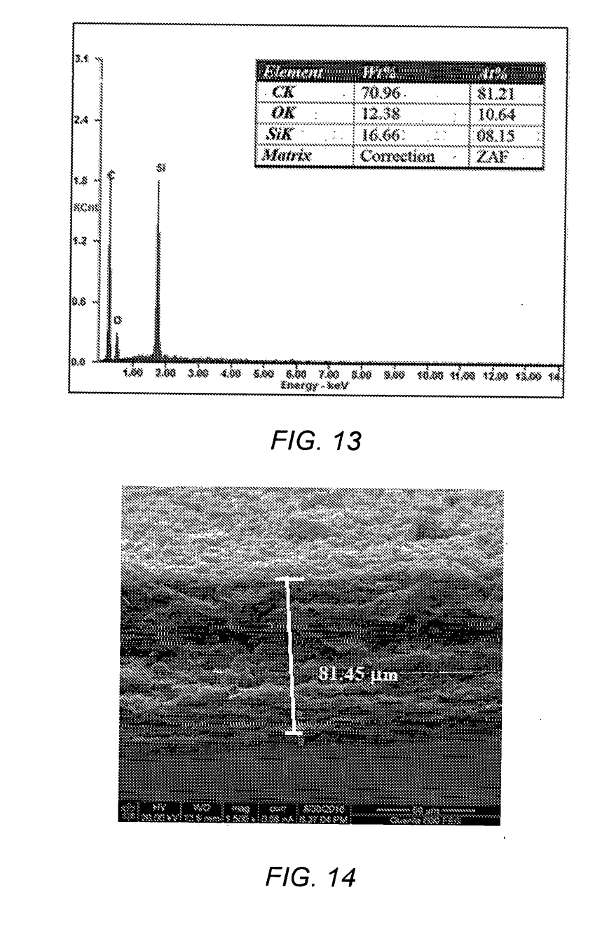

FIGS. 10 and 11 are the SEM image of a cross-sectional portion of the Si@SiO₂/rGO film. Layered graphene film (arrow rGO) and encapsulated Si@SiO₂ (dotted circles) were observed. Dotted circles on the image are used to highlight some of the encapsulated Si@SiO₂ in the layered graphene film. FIG. 12 is the SEM image of Si@SiO₂/rGO film prepared for EDX analysis. The portion inside the square was selected for EDX analysis. From the EDX results (FIG. 13) it was determined that the film was composed of the elements carbon, oxygen and silicon.

### Example 4

### Synthesis and Characterization of Si/Reduced Graphene Oxide Composite Yolk-Shell Membrane (Si/rGO)

The Si@SiO₂/rGO film of Example 3 was immersed in 10% hydrogen fluoride (HF) for 1 hour and then washed with water until neutral pH is obtained

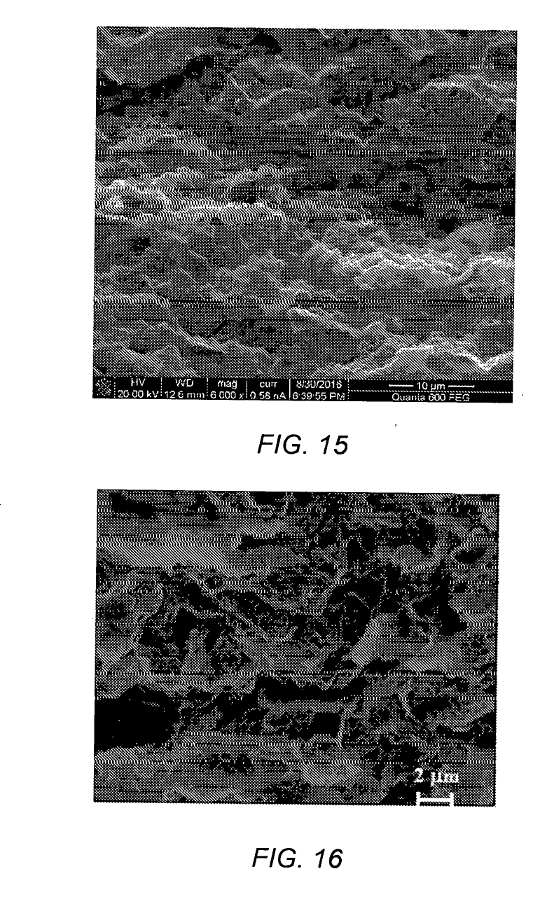

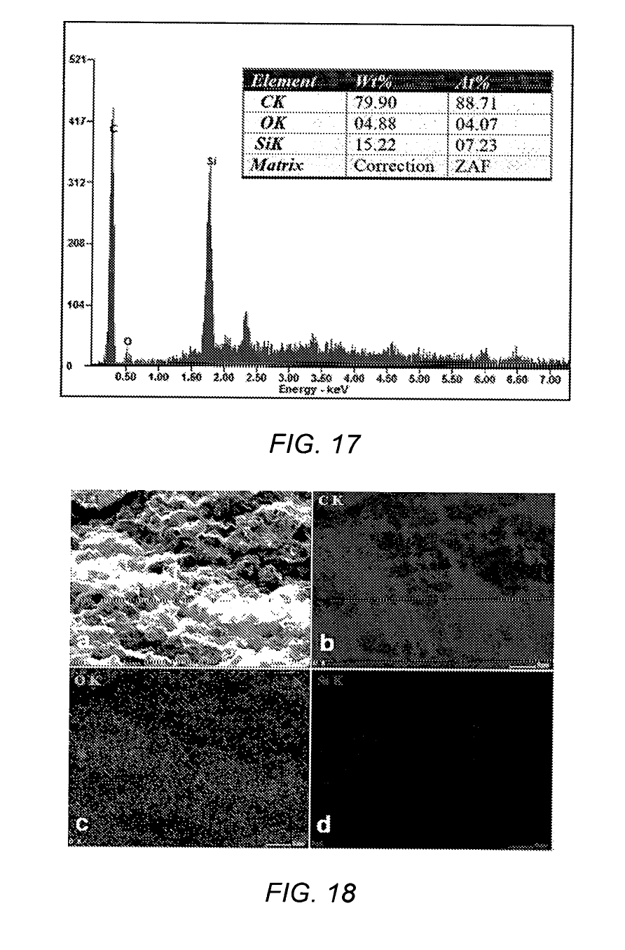

FIGS. 14 and 15 are the SEM images of cross-sectional Si/rGO yolk/shell film. From the SEM image, bubbled graphene shell was observed. The film had a thickness of 81.45 μm. FIG. 16 is the SEM image of Si/rGO yolk/shell film for EDX analysis. From the EDX results (FIG. 17) it was determined that the content of silicon and oxygen atoms are reduced when compared with FIG. 13. Without wishing to be bound by theory, it is believed this reduction is due to SiO₂ etched by HF. In addition, the O atom loss was approximately six times of Si, which meant that most O atom loss was from graphene oxide. FIG. 18 shows elemental distribution maps were collected for the Si/rGO yolk-shell film. From these maps, it was determined that C, O, and Si atoms were uniformly distributed in the Si/rGO yolk-shell film.

1. A multi-layered graphene material comprising a plurality of graphene layers having a plurality of intercalated nano- or microstructures that form a plurality of yolk/shell type structures, each yolk/shell type structure comprising at least two graphene layers that form a shell-like structure that encompasses a void space having at least one of the plurality of nano- or microstructures, wherein the void space has a volume sufficient to allow for volume expansion of the at least one of the plurality of nano- or microstructures without deforming the shell-like structure.

2. The multi-layered graphene material of claim 1, wherein the void space has a volume sufficient to allow for at least 50% volume expansion, preferably 200% to 600% volume expansion of the at least one of the plurality of nano- or microstructures without deforming the shell-like structure.

3. The multi-layered graphene material of claim 1, wherein each of the plurality of yolk-shell type structures encompasses a single nano- or microstructure or at least two nano- or microstructures.

4. The multi-layered graphene material of claim 1, wherein the nano- or microstructure(s) fills 1% to 80%, or 30% to 60%, of the volume of each void space.

5. The multi-layered graphene material of claim 1, wherein the average volume of each void space is 5 nm³ to 10⁶ μm³.

6. The multi-layered graphene material of claim 1, wherein the plurality of yolk-shell type structures are configured to allow fluid, gas, or ions to enter and exit the structures.

7. The multi-layered graphene material of claim 1, wherein the material has a flow flux of 1×10⁻⁹ to 1×10⁻⁴ mol m⁻²s⁻¹Pa.

8. The multi-layered graphene material of claim 1, wherein the plurality of yolk-shell type structures are configured to retain the plurality of nano- or microstructures in the void spaces.

9. The multi-layered graphene material of claim 1, wherein the graphene layers are reduced graphene oxide layers.

10. The multi-layered graphene material of claim 1, wherein the nano- or microstructures comprise silicon or an oxide or alloy thereof.

11. The multi-layered graphene material of claim 1, wherein the nano- or microstructures comprises a metal, a metal oxide, a carbon-based nano- or microstructure, a metal organic framework, a zeolitic imidazolated framework, a covalent organic framework, or any combination thereof.

12. The multi-layered graphene material of claim 11, wherein the metal is a noble metal selected from the group consisting of palladium (Pd), platinum (Pt), gold (Au), rhodium (Rh), ruthenium (Ru), rhenium (Re), or iridium (Ir), osmium (Os), any combinations or alloys thereof or a transition metal selected from the group consisting of silver (Ag), copper (Cu), iron (Fe), nickel (Ni), zinc (Zn), manganese (Mn), chromium (Cr), molybdenum (Mo), tungsten (W), or tin (Sn), or any combinations or oxides or alloys thereof.

13. The multi-layered graphene material of claim 1, wherein each nano- or microstructures has a diameter of 1 nm to 1000 nm, preferably 1 nm to 50 nm, or more preferably 1 nm to 5 nm.

14. The multi-layered graphene material of claim 1, wherein the material is in the form of a sheet or film, wherein the sheet or film has a thickness of 10 nm to 500 μm.

15. The multi-layered graphene material of claim 1, wherein the material comprises 10 wt. % to 90 wt. % of the plurality of nano- or microstructures.

16. An energy storage device comprising the multi-layered graphene material of claim 1.

17. The energy storage device of claim 16, wherein the energy storage device is a rechargeable battery.

18. A catalytic membrane for catalyzing a chemical reaction, the membrane comprising the multi-layered graphene material of claim 1.

19. A method of making the multi-layered graphene material of claim 1, the method comprising:
(a) obtaining a composition comprising a plurality of graphene oxide layers having a plurality of intercalated composite nano- or microstructures that form a plurality of core/shell type structures, each core/shell type structure comprising at least two graphene layers that form a shell-like structure that encompasses at least one of the plurality of composite nano- or microstructures, wherein the composite nano- or microstructures comprise a removable polymeric matrix; and
(b) calcining the composition to reduce the graphene oxide layers to graphene layers and to remove the polymeric matrix to produce the multi-layered graphene material of claim 1.

20. A method of making the multi-layered graphene material of claim 1, the method comprising:
(a) obtaining a composition comprising a plurality of graphene oxide layers having a plurality of intercalated nano- or microstructures that form a plurality of core/shell type structures, each core/shell type structure comprising at least two graphene layers that form a shell-like structure that encompasses at least one of the nano- or microstructures of the plurality of intercalated nano- or microstructures;
(b) calcining the composition to reduce the graphene oxide layers to graphene layers; and
(c) partially etching away the plurality of intercalated nano- or microstructures to produce the multi-layered graphene material of any one of claims 1 to 19, wherein partial etching of the plurality of nano- or microstructures converts the core/shell type structure into a yolk/shell type structure that encompasses a void space having at least one nano- or microstructure, wherein the void space has a volume sufficient to allow for volume expansion of the at least one nano- or microstructure without deforming the shell-like structure.
